(19) United States
(12) Patent Application Publication
(10) Pub. No.: US 2026/0200954 A1
(43) Pub. Date: Jul. 16, 2026

(54) SYNTHESIS OF METAL-ORGANIC FRAMEWORK (MOF)-BASED ADSORBENT MATERIALS

(71) Applicant: Cummins Filtration Inc., Nashville, TN (US)

(72) Inventors: Zhigang Hu, Shanghai (CN); Brian W. Schwandt, Stoughton, WI (US); Jiaxi Zhang, Shanghai (CN); Yiyun Zhang, Shanghai (CN); Fan Yang, Shanghai (CN); Shuanghua Xu, Shanghai (CN)

(73) Assignee: Cummins Filtration Inc., Nashville, TN (US)

(21) Appl. No.: 19/041,634

(22) Filed: Jan. 30, 2025

(30) Foreign Application Priority Data
Jan. 16, 2025 (CN) 202510072141.2

(51) Int. Cl. C07F 7/00; B01J 20/22

(52) U.S. Cl. CPC C07F 7/00; B01J 20/226

(57) ABSTRACT

A method of producing a MOF-based material is provided. The method can include preparing an aqueous solution that includes a first reactant, a second reactant different from the first reactant, and a reaction modulator. The first reactant can include a metal compound and the second reactant can include an organic ligand. The method can include synthesizing a crude product that includes a metal-organic frameworks (MOFs)-based material in the aqueous solution. The MOFs-based material can have a structure that includes a metal ion or a metal cluster of the first reactant linked by the organic ligand of the second reactant. The method can include extracting the crude product from the aqueous solution. The method can include purifying the extracted crude product. The method can further include drying the purified crude product to obtain the MOFs-based material.

### TECHNICAL FIELD

The present application claims priority to Chinese Application No. 202510072141.2, filed Jan. 16, 2025. The contents of this application are incorporated herein by reference in its entirety and for all purposes

The present invention relates generally to methods of preparing metal-organic framework (MOF)-based adsorbent materials for removing gaseous pollutants.

### BACKGROUND

With the increase of the amount of toxic gas emission, negative influence of toxic gases and gaseous pollutants on environmental sustainability and global climate has attracted much attention. For example, the accumulation of sulfur dioxide (SO₂) and nitrogen dioxide (NO₂) contributes to the formation of photochemical smog and acid rain. Since such toxic gases and gaseous pollutants severely threaten human health and the environment, it is necessary to develop effective technologies to remove them and thus reduce their side effects. Flow gases generated by industrial production processes and power plants normally contains an ultralow concentration of SO₂ (e.g., at 500 ppm to 2000 ppm) and NO₂ (e.g., at 500 ppm to 2000 ppm), while the concentration of those gases in automotive exhaust emissions can be even lower (e.g., at 10 ppm to 100 ppm). The release of SO₂ and NO₂ could exert detrimental effects on the environment and human health.

Metal-organic framework (MOF)-based materials are a class of porous materials generally having a crystal structure that grows or extends periodically in two- or three-dimensions. They are promising candidates as adsorbent materials for the capture and removal of toxic gases and gaseous pollutants over other alternative materials and/or methods that require relatively higher cost and/or more intensive energy since MOF-based materials have rich library of abundant building blocks, including metal cores (e.g., metal ions, metal clusters, etc.) and organic ligands. While existing MOF-based materials and their methods of production have been generally adequate, they are not entirely satisfactory in all aspects.

For example, the currently reported capabilities of MOF-based materials for capturing SO₂ and NO₂ are predominantly focused on concentrations above 2000 ppm and 1000 ppm, respectively. For instance, it has been reported that an adsorbent including SNFSIX-Cu-TPA exhibited an SO₂ adsorption capacity of up to 1.52 mmol g⁻¹ under simulated flue gas conditions (e.g., at 2000 ppm of SO₂ in a mixture of 10% CO₂ and 89.8% N₂). Furthermore, under the condition of a mixture containing 99.95% N₂ and 500 ppm SO₂, its SO₂ adsorption capacity remained as high as 1.33 mmol g⁻¹. Similarly, it has been reported an unprecedented SO₂ adsorption capacity of 4.27 mmol g⁻¹ at 500 ppm for a partially fluorinated version of MIL-101 (Cr), termed MIL-101 (Cr)-4F (1%). Furthermore, a MOF with abundant Mg²⁺ open metal sites, Mg₂(dobpdc) was reported, demonstrating an outstanding SO₂ adsorption capacity of 2.35 mmol g⁻¹ at 298 K and 2000 ppm.

Regarding NO₂, it has been reported that a copper-based CuBTC MOF and its derived carbon materials exhibited NO₂ adsorption capacities of 4.97 mmol g⁻¹ and 1.09 mmol g⁻¹, respectively, at 1000 ppm. Additionally, it has been reported that the Zr-bptc MOF exhibited excellent NO₂ adsorption capacities of 4.9 mmol g⁻¹ and 4.0 mmol g⁻¹ at 2500 ppm under 75% relative humidity (RH) and dry mixed gas conditions, respectively. Furthermore, it has been reported that Al-PMOF demonstrated NO₂ adsorption capacities of 1.85 mmol g⁻¹ and 3.61 mmol g⁻¹ under 60% RH and dry conditions, respectively, in a mixture containing 200 ppm NO₂. Despite numerous advances in the adsorption capacity of the MOF-based materials for capturing toxic gases such as SO₂ and NO₂, there remains a need for improving the adsorption capacity of the MOF-based materials for capturing SO₂ and NO₂ at concentrations of 200 ppm or lower, which is critically important for potential applications.

In addition, despite their promising properties, such as highly specific surface areas (i.e., high porosity), green and mild scalable synthesis of such MOF-based materials remains a challenge for industrial applications. Currently, various existing methods for synthesizing UiO-66-type MOF-based materials rely on traditional solvothermal methods, which generally involve relatively longer reaction time, relatively higher temperature, relatively higher pressure, the use of toxic organic solvents, and low purification yield. While recently developed methods, such as solvent-free mechanical grinding synthesis, cathodic electrochemical synthesis, sono-chemical synthesis, and microfluidic flow synthesis, have improved environmental sustainability, they still face difficulties in achieving rapid (e.g., shorter synthesis time), scalable, high-quality synthesis of MOF-based materials.

### SUMMARY OF THE INVENTION

In one aspect of the present disclosure, a method of producing a MOF-based material is provided. The method includes preparing an aqueous solution that includes a first reactant, a second reactant different from the first reactant, and a reaction modulator. The first reactant includes a metal compound (e.g., a metal salt), and the second reactant can include an organic ligand. The method includes synthesizing a crude product that includes a metal-organic framework (MOF)-based material in the aqueous solution. The MOFs-based material has a structure that includes a metal core of the first reactant linked by the organic ligand of the second reactant. The method includes extracting the crude product from the aqueous solution. The method includes purifying the extracted crude product. The method further includes drying the purified crude product to obtain the MOFs-based material.

In another aspect of the present disclosure, a method of producing MOF-based materials is provided. The method includes preparing an aqueous solution that includes a first reactant, a second reactant different from the first reactant, and a reaction modulator. The first reactant includes a metal compound, and the second reactant includes an organic ligand. The method includes synthesizing a crude product that includes a MOF-based material in the aqueous solution. The MOF-based material can have a structure that includes a metal core of the first reactant linked by the organic ligand of the second reactant. Synthesizing the crude product includes heating the aqueous solution in an oil bath and mechanically stirring the aqueous solution. The method includes extracting the crude product from the aqueous solution using a first diluent that includes water. The method includes purifying the extracted crude product using a second diluent that includes alcohol. The method further includes drying the purified crude product to obtain the MOF-based material.

In yet another aspect of the present disclosure, a MOF-based material is provided. The MOF-based material is produced by the method provided herein. The MOF-based material has a UiO-66-type structure that includes the metal core of the first reactant linked by the organic ligand of the second reactant. The metal core includes zirconium (Zr) or hafnium (Hf). The organic ligand includes one or more of —NH₂, —OH, —F, and —COOH.

In still another aspect of the present disclosure, an adsorbent is provided. The adsorbent includes a MOF-based material produced by the method provided herein.

### BRIEF DESCRIPTION OF THE DRAWINGS

FIG. 1 shows a flowchart of an example method for producing and testing a sample including a MOF-based material.

FIG. 2 shows a schematic diagram of the example method of FIG. 1.

FIG. 3 shows examples of different MOF-based materials.

FIG. 4 shows powder X-ray diffraction (p-XRD) spectra of example MOF-based materials synthesized using methods provided herein compared against a p-XRD spectrum of a reference MOF-based material.

FIG. 5 shows a field emission scanning electron microscope (FE-SEM) image of an example MOF-based material including (Zr)UiO-66-(OH)₂ and synthesized using methods provided herein.

FIG. 6 shows a FE-SEM image of an example MOF-based material including (Zr)UiO-66-NH₂ and synthesized using methods provided herein.

FIG. 7 shows N₂ isotherms measured at 77 K of example MOF-based materials synthesized using methods provided herein.

FIG. 8 shows pore width distribution of example MOF-based materials synthesized using methods provided herein.

FIG. 9 shows SO₂ adsorption isotherms of example MOF-based materials synthesized using methods provided herein.

FIG. 10 shows NO₂ adsorption isotherms of example MOF-based materials synthesized using methods provided herein.

FIG. 11 shows breakthrough curves of a 0.003%/99.997% SO₂/N₂ mixture gas in example MOF-based materials synthesized using methods provided herein.

FIG. 12 shows breakthrough curves of a 0.01%/99.99% SO₂/N₂ mixture gas in example MOF-based materials synthesized using methods provided herein.

FIG. 13 shows breakthrough curves of a 0.1%/99.9% SO₂/N₂ mixture gas in example MOF-based materials synthesized using methods provided herein.

FIG. 14 shows breakthrough curves of a 0.003%/99.997% NO₂/N₂ mixture gas under 70% RH in example MOF-based materials synthesized using methods provided herein.

### DETAILED DESCRIPTION

Embodiments of the present disclosure provide methods of synthesizing water-stable MOF-based materials with improved adsorption capacities for capturing harmful gases (e.g., SO₂ and NO₂) at low or extremely low concentrations, such as at 30 ppm and 100 ppm. Structures of MOF-based materials obtained using the methods provided herein include a structure having building units of a metal core (or metal center), such as a metal ion or a metal cluster, linked or coupled to multiple organic ligands. In various embodiments, the methods of producing MOF-based materials provided herein address one or more challenges related to the state of existing technologies, which face challenges such as long synthesis time, stringent condition, significant environmental pollution, poor crystallization quality, uncontrolled growth process, difficulty in scalable synthesis, and complex testing system.

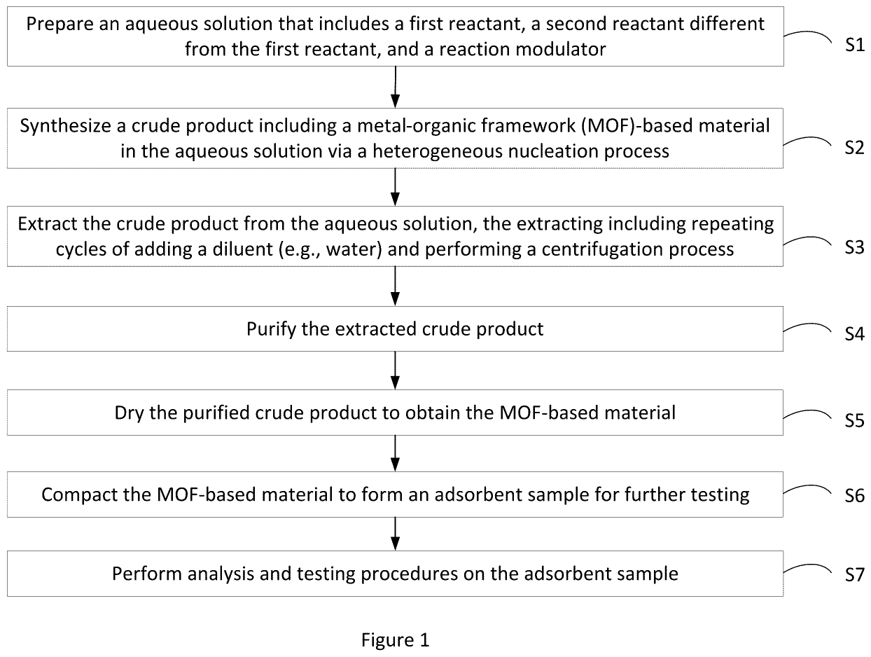

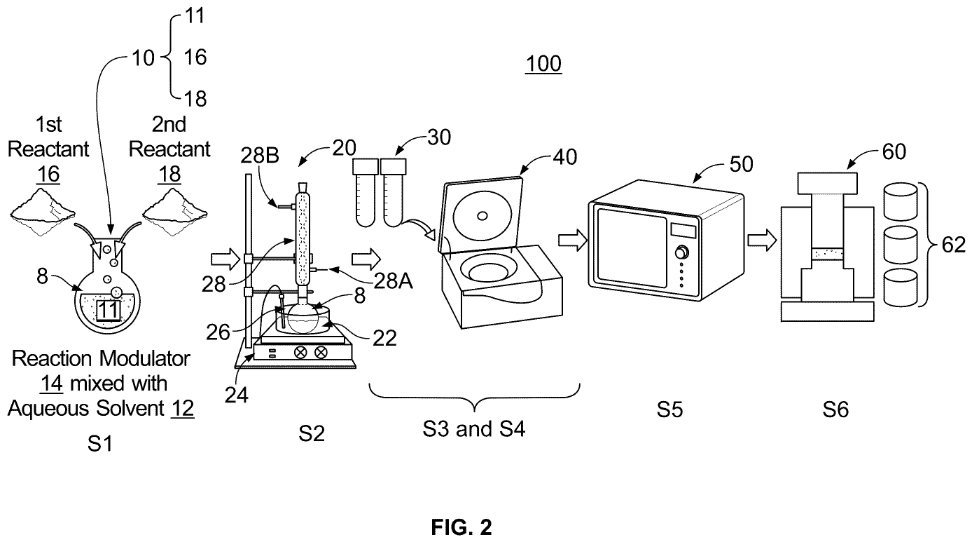

Referring to FIG. 1, an example method (or process) 100 of producing a MOF-based material (e.g., a UiO-66-type MOF) is provided. It should be noted that the method 100 is merely an example and is not intended to limit the present disclosure. Furthermore, it is understood that additional processes may be provided before, during, and after the method 100 of FIG. 1. Intermediate processes of the method 100 may be associated with and described in reference to FIGS. 1 and 2, where FIG. 2 illustrates various example apparatuses that may be implemented at the correspondingly labeled intermediate processes of the method 100 as shown in FIG. 1.

At S1, an aqueous solution 10 is prepared in a reaction vessel 8 as shown in FIG. 2. In the present embodiments, the aqueous solution 10 includes a mixture of a reaction modulator 14, a first reactant 16, and a second reactant 18 dissolved in (or otherwise mixed with) an aqueous solvent 12.

In some embodiments, the aqueous solvent 12 consists essentially of water, such as deionized (DI) water, and the reaction modulator 14 includes carboxylic acid (or carboxylate) or a variation thereof. In some embodiments, the moderator 14 aids in the synthesis of the metal cores (e.g., metal clusters) in the MOF-based material. In one such example, the reaction modulator 14 includes acetic acid. Alternatively or additionally, the moderator 14 may include formic acid, benzoic acid, acetic acid, and trifluoroacetic acid, other suitable acids, or combinations thereof. The first reactant 16 includes a metal compound from which the metal core of the MOF-based material is obtained. In some embodiments, the metal compound is an ionic compound, such as a metal salt, of a transition metal. For embodiments in which the MOF-based material has a UiO-66-type structure, the transition metal includes zirconium (Zr), hafnium (Hf), other suitable transition metals, or combinations thereof. The second reactant 18 includes organic ligands configured to link to the metal core to form a suitable coordination complex of the MOF-based material. Examples of the second reactant 18 may include terephthalic acid (BDC), functionalized terephthalic acid, or a combination thereof. In some examples, the second reactant 18 includes benzene-1,3,5-tricarboxylic acid (BTC) (i.e., trimesic acid), 1,3,5-tris(4-carboxyphenyl)benzene (BTB), 2,5-dyhydroxy terephthalic acid, 2-amino terephthalic acid, or other suitable terephthalic acid-based organic ligands capable of forming MOFs with Zr- or Hf-based metal cores.

In some embodiments, preparing the aqueous solution 10 includes mixing the reaction modulator 14, the first reactant 16, and the second reactant 18 in the aqueous solvent 12 in a suitable order. In an example embodiment, the reaction modulator 14 is first mixed with the aqueous solvent 12 to prepare a solvent mixture 11, and the first reactant 16 and the second reactant 18 are subsequently dissolved in the solvent mixture 11 to form the aqueous solution 10 in the reaction vessel 8. The first reactant 16 and the second reactant 18 may be added to the solvent mixture 11 sequentially or simultaneously. In another example embodiment, the reaction modulator 14, the first reactant 16, and the second reactant 18 are dissolved in (or otherwise mixed with) the aqueous solvent 12 simultaneously. In some embodiments, preparing the aqueous solution 10 is facilitated by mechanical stirring in a continuous manner, resulting in even distribution of the reactants in the solvent mixture 11.

In an example embodiment, preparing the aqueous solution 10 begins with first mixing about 3000 mL of the aqueous solvent 12 with about 2000 mL of the reaction modulator 14 to form the solvent mixture 11. Subsequently, preparing the aqueous solution 10 proceeds to dissolving, in a sequential manner, for example, about 520 mmol of the first reactant 16 and about 500 mmol of the second reactant 18 in the solvent mixture 11, followed by stirring to achieve even distribution of the reactants.

At S2, a crude product 30 including a MOF-based material is synthesized from the aqueous solution 10 utilizing reaction apparatus 20 as shown in FIG. 2. In the present embodiments, the crude product 30 obtained from the S2 includes the MOF-based material and the solvent mixture 11 containing the aqueous solvent 12 and the reaction modulator 14.

In the present embodiments, synthesizing the crude product 30 includes heating the aqueous solution 10 in a thermal bath 22 and stirring the aqueous solution 10 to facilitate the reaction between the first reactant 16 and the second reactant 18. In some embodiments, heating and stirring the aqueous solution 10 are implemented simultaneously. In some embodiments, heating and stirring the aqueous solution 10 are implemented sequentially.

In some embodiments, the aqueous solution 10 is stirred at a rate of about 100 rpm to about 2000 rpm. In an example embodiment, the aqueous solution 10 is stirred at a rate of about 600 rpm. In various embodiments, the rate of stirring influences kinetics of the crystal growth process, thereby affecting sizes and surface areas of the resulting crystals. When the aqueous solution 10 is stirred at a rate within the range of about 100 rpm to about 2000 rpm, the sizes and the surface areas of the crystals may be tuned to desired values. If the aqueous solution 10 is stirred at a rate below about 100 rpm, however, precipitates and uneven crystals may form. On the other hand, if the aqueous solution 10 is stirred at a rate above 2000 rpm, the sizes of the resulting crystals may be limited (e.g., much smaller than desired).

In the present embodiment, the synthesis of the MOF-based material is implemented as a reflux condensation heating process, and for this reason, the reaction apparatus 20 may be referred to as a reflux heating apparatus. Referring to FIG. 2, for example, the reaction apparatus 20 includes the thermal bath 22 in which the reaction vessel 8 may be placed, a hot plate 24 configured to heat the thermal bath 22, and a condenser 28 coupled to an open end of the reaction vessel 8. The thermal bath 22 may include any suitable heating medium, such as oil or water, and may be placed in thermal contact with a heated surface of the hot plate 24. In some embodiments, the thermal bath 22 is placed in direct contact with the hot plate 24.

In the present embodiments, the hot plate 24 is configured to both provide heat to the thermal bath 22 and to facilitate mixing of the aqueous solution 10. In this regard, the hot plate 24 may include heating elements (e.g., electrical heating elements) and a stirrer (not depicted separately in FIG. 2) that can be operated independently of each other. In some embodiments, the stirrer is a mechanical stirrer, such as a magnetic stirrer operated with a magnetic stir bar. In some embodiments, the hot plate 24 is configured to provide heat to the thermal bath 22, and the reaction apparatus 20 further includes a separate stirrer (not depicted herein) configured to mix the aqueous solution 10.

The reaction apparatus 20 may further include a thermometer 26 configured to measure the temperature of the thermal bath 22. By monitoring the temperature of the thermal bath 22 using the thermometer 26, the hot plate 24 can be controlled by adjusting the temperature setting of its heating function and/or a magnitude of stirring of its stirring function. The condenser 28 may be removably coupled to the opening of the reaction vessel 8 and cooled by a cooling medium, such as water, in a continuous manner during the heating process. The cooling medium may be provided to the condenser 28 through an inlet 28A and removed from the condenser 28 through an outlet 28B. In this manner, any vapor produced by heating the solvent mixture 11 of the aqueous solution 10 may be effectively collected by the cooled condenser 28 and returned to the reaction vessel 8 via the condenser 28 along the length of the condenser 28. As a result, loss of the reactants 16 and 18 and/or the reaction modulator 14 is reduced or minimized during the synthesis process, improving a yield of the synthesis process.

By using the thermal bath 22, the aqueous solution 10 is heated indirectly and in a controllable manner to prevent formation of uneven heat pockets and to ensure uniform heat conduction throughout the aqueous solution 10 in the reaction vessel 8. Furthermore, continuous stirring the aqueous solution 10 enhances mass and heat transfer processes between the various components of the aqueous solution 10 (e.g., the reaction modulator 14, the first reactants 16, and the second reactant 18), thereby further accelerating (i.e., reducing reaction time) the formation of the MOF-based material. The combination of heating via the thermal bath 22 and continuous stirring ensures that the synthesis process occurs in a thermally uniform and controllable manner, facilitating and/or accelerating uniform nucleation and growth of the crystal structure of the MOF-based material. Advantageously, when implemented in combination, the heating and the stirring processes ensure compositional homogeneity in the resulting MOF-based material.

Furthermore, implementing the heating and the stirring process in this manner promotes heterogeneous nucleation and metal-organic exchange reaction growth between the metal cores (from the first reactant 16) and the organic ligands (from the second reactant 18) present in the aqueous solution 10. In some embodiments, the heterogeneous nucleation and the metal-organic exchange reaction growth reduces energy barrier (i.e., activation energy of the synthesis process) of a direct, one-step synthesis process for forming the MOF-based material, resulting in rapid nucleation and growth of the crystal structure. In addition, utilizing the condenser 28 to collect and return vapor produced during the synthesis process improves yield of the resulting MOF-based material.

In comparison to the existing technologies, reacting the first reactant 16 and the second reactant 18 (in the presence of the reaction modulator 14 and the aqueous solvent 12) in the reaction apparatus 20 at S2 provided herein lowers the temperature, pressure, and duration required to implement the synthesis of the MOF-based materials. In some embodiments, the aqueous solution 10 is heated to a temperature of about 60° C. to about 150° C. at S2 to ensure that sufficient thermal energy is provided to the reactants in the aqueous solution 10 for nucleation and growth of the crystal structure of the MOF-based material to occur. If the aqueous solution 10 is heated to a temperature below about 60° C., insufficient thermal energy may lead to incomplete crystallization, which may affect the overall yield of the synthesis process. On the other hand, if the aqueous solution is heated to a temperature above about 150° C., excess thermal energy could limit the growth of crystals, resulting in crystals with relatively smaller sizes. In some embodiments, the aqueous solution 10 is kept at atmospheric pressure (i.e., 1 atm or 1013.25 mbar) in the reaction apparatus 20 during the synthesis process. In various embodiments, the ability to implement the synthesis process at a relatively lower pressure, such as at atmospheric pressure, advantageously allows the synthesis process to be carried out in a continuous manner and be more conducive to upscaling. In addition, a relatively lower pressure also improves safety of the synthesis process, further enhancing the capability to upscale the production of the MOF-based material as described herein. In some embodiments, the heating and the stirring of the aqueous solution 10 are implemented for a duration of about 6 hours to about 12 hours to ensure that the synthesis process proceeds to completion.

Accordingly, such improvement in conditions for the synthesis process, is coupled with an aqueous and/or alcohol-based solvent system (i.e., the aqueous solvent 12 and the reaction modulator 14) and enhanced scalability that is afforded by the simple reflux condensation heating apparatus (i.e., the reaction apparatus 20), the methods provided herein (e.g., the method 100) offer simplified, scalable, and environmentally friendly solutions to the production of MOF-based materials suitable for capturing trace amounts of toxic gases at lower cost and higher adsorption efficiency.

In an example embodiment, synthesizing the crude product 30 includes heating the aqueous solution 10 in the thermal bath 22 at a temperature of about 95° C., and stirring the aqueous solution 10 using a magnetic stirrer at a rate of about 600 rpm for about six hours. Conditions such as these allow rapid synthesis of the MOF-based material by utilizing the principle of heterogeneous nucleation of the organic ligands (e.g., from the second reactant 18) in the metal core-containing (e.g., from the first reactant 16) aqueous solution 10, resulting in improved growth rate (or reaction rate) of the metal core-ligand exchange reaction as well as enhanced homogeneity of the resulting MOF-based material.

At S3, the crude product 30, which contains the MOF-based material, is extracted from the reacted aqueous solution 10 after completing the synthesis process at S2. In some embodiments, the reacted aqueous solution 10 is cooled to room temperature and collected for the extraction process. The extraction process may be implemented in any suitable apparatus, such as a centrifuge apparatus 40 as shown in FIG. 2.

In some embodiments, an initial (i.e., a first) centrifugation process is performed to the reacted aqueous solution 10 to separate the crude product 30 from the solvent mixture 11 of the reacted aqueous solution 10. After discarding the supernatant, which includes the solvent mixture 11, a first diluent (or cleaning solvent) is then added to and mixed with the separated crude product 30, and the mixture is allowed to settle for an extended period of time. In an example embodiment, the mixture is allowed to settle for about 12 hours. In some embodiments, the first diluent includes an aqueous solvent, such as water (e.g., DI water). Thereafter, an extraction (i.e., a second) centrifugation process is performed to separate the crude product 30, followed by discarding of the supernatant, which includes the added first diluent. In the present embodiments, the cycle of adding the first diluent, performing the extraction centrifugation process, and discarding the supernatant is repeated multiple times to obtain the extracted (or separated) crude product 30. In some examples, the cycle may be repeated three times, though the present disclosure is not limited as such.

At S4, the extracted crude product 30 is further purified. In some embodiments, the purification process includes adding a second diluent to the extracted crude product 30 obtained at S3, performing a purification (i.e., a third) centrifugation process, and subsequently discarding the supernatant that includes the added second diluent. In some embodiments, the second diluent includes an alcohol, such as anhydrous ethanol or anhydrous methanol. In the present embodiments, similar to S3, the cycle of adding the second diluent, performing the purification centrifugation process, and discarding the supernatant is repeated multiple times to obtain the purified crude product 30. In some examples, the cycle may be repeated three times, though the present disclosure is not limited as such. In some embodiments, the implementations of S3 and S4 also activates the MOF-based material in the crude product 30 during the purification process at S4. In some examples, a duration for implementing the extraction process at S3 and the purification process at S4 may be about 72 hours, though the present disclosure is not limited as such.

At S5, the purified crude product 30 is dried to obtain the MOF-based material. In some embodiments, drying the purified crude product 30 is implemented in a vacuum environment and at an elevated temperature for an extended period of time. In some examples, the purified crude product 30 may be dried at about 120° C. in a vacuum drying apparatus 50 as shown in FIG. 2 and for about 12 hours, though the present disclosure is not limited by these conditions. In some embodiments, the dried MOF-based material is in the form of a high-purity and high-quality powder. In some embodiments, the purified crude product 30 is freeze-dried to form the high-purity and high-quality powder.

At S6, the MOF-based material is compacted (or pressed) to form one or more blocks of adsorbent samples 62 for further testing and analysis. In some embodiments, compacting the MOF-based material is implemented by applying pressure to the MOF-based material in a compactor apparatus 60 as shown in FIG. 2. In some examples, it may require about 10 MPa of pressure to produce the adsorbent samples 62 from powdered MOF-based material, though the present disclosure is not limited as such.

At S7, various analysis and testing procedures are performed on the adsorbent samples 62 of the MOF-based material. In some embodiments, the analysis and testing procedures are performed to evaluate various physical properties of the MOF-based material, as well as their adsorption capacities for capturing trace concentrations (e.g., less than 100 ppm) of SO₂ and NO₂. In some embodiments, evaluating the adsorption capacity includes deconstructing (e.g., crushing) the adsorbent samples 62 into an adsorption bed and performing a gas penetration test on the adsorbent samples 62. In some examples, the adsorption capacity of the MOF-based material may be evaluated using a custom-made breakthrough system.

In some examples, the MOF-based material is tested for adsorption of SO₂ at 30 ppm and 100 ppm, respectively, and for adsorption of NO₂ at a concentration of 30 ppm. As a result, the grand canonical Monte Carlo (GCMC) simulations calculated adsorption performance of UiO-66-(OH)₂ for SO₂ and NO₂ at the concentration of 30 ppm is about 4.52 mmol g⁻¹ and about 12.35 mmol g⁻¹, respectively. An experimental SO₂ capture capacities at 30 ppm of UiO-66-(OH)₂ and UiO-66-NH₂ are about 0.06 mmol g⁻¹ and about 0.10 mmol g⁻¹, respectively.

Generally, MOF-based materials obtained using the method 100 provided herein have the following properties: intrinsic microporosity, adjustable pore sizes, and multiple controllable functionalities. By performing the processes of the method 100 (e.g., S2), structures of MOF-based materials are formed from building units including the metal core (or metal center), such as a metal ion or a metal cluster, of the first reactant 16 linked or coupled to the organic ligands of the second reactant 18. In some embodiments, the metal core includes a transition metal in an ion form or a cluster form. In some embodiments, the organic ligands are multifunctional (i.e., including multiple functional groups).

Advantageously, strong coordination between the metal core and the organic ligands endows the MOF-based materials provided herein with improved thermal stability, as well as stability in various solvents, such as organic solvents, water, and acidic aqueous solutions. Moreover, the well-developed microporous structure, combined with defect structures and the polar effects of functional groups, provides these MOF-based materials with improved SO₂ and NO₂ adsorption capabilities (or capture capabilities), demonstrating significant advantages over other existing trace gas capture technologies utilizing materials such as activated carbon. In some embodiments, the MOF-based materials synthesized using methods provided herein demonstrate measurable adsorption capabilities at ultralow concentration levels (e.g., 30 ppm and 100 ppm) of SO₂ and NO₂, respectively. For example, experimental results provided herein demonstrate adsorption capabilities of about 0.05-0.30 mmol g⁻¹ (e.g., about 0.06 mmol g⁻¹, about 0.10 mmol g⁻¹, etc.) at a concentration level of 30 ppm SO₂, about 0.10 mmol g⁻¹ (e.g., 0.12 mmol g⁻¹, 0.16 mmol g⁻¹, etc.) at a concentration level of 100 ppm SO₂, and 0.0001-0.01 mmol g⁻¹ (e.g., 0.0003 mmol g⁻¹, 0.006 mmol g⁻¹, etc.) at a concentration level of 30 ppm NO₂.

In the present embodiments, the MOF-based materials are of the UiO-66 type as described above. In this regard, the metal core of the MOF may include Zr, Hf, other suitable transition metals, or combinations thereof, and the organic ligands may include terephthalic acid or a variation thereof (e.g., BDC, BTC, or BTB) as described above. In some embodiments, the organic ligands include terephthalic acid functionalized with one or more of —NH₂, —OH, —F, and —COOH.

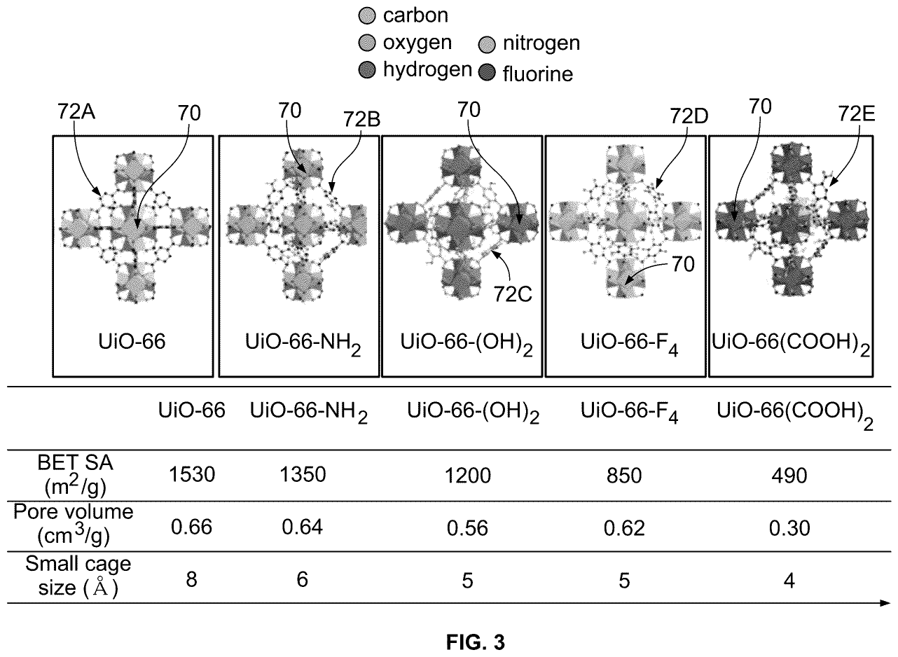

FIG. 3 illustrates different MOF-based materials synthesized from a metal core 70 that includes Zr and organic ligands 72A, 72B, 72C, 72D, and 72E (collectively referred to as organic ligands 72) of different chemical compositions and their corresponding physical properties. For example, the MOF-based material denoted “UiO-66” is synthesized from the organic ligands 72A including terephthalic acid without other functional groups; the MOF-based material denoted “UiO-66-NH₂” is synthesized from the organic ligands 72B including terephthalic acid functionalized with —NH₂; the MOF-based material denoted “UiO-66-(OH)₂” is synthesized from the organic ligands 72C including terephthalic acid functionalized with —OH; the MOF-based material denoted “UiO-66-F₄” is synthesized from organic ligands 72D including terephthalic acid functionalized with —F; and the MOF-based material denoted “UiO-66-(COOH)₂” is synthesized from organic ligands 72E including terephthalic acid functionalized with —COOH. In this regard, the organic ligands 72A includes carbon (C) and oxygen (O); the organic ligands 72B includes C, O, nitrogen (N), and hydrogen (H); the organic ligands 72C includes C, O, and H; the organic ligands 72D includes C and fluorine (F); and the organic ligands 72E includes C, O, and H. It is noted that the MOF-based materials shown in FIG. 3 are simply for illustration purposes and other MOF-based materials with UiO-66-type of structures may also be synthesized using the methods (e.g., the method 100) provided herein.

Furthermore, the method of producing such MOF-based materials as provided herein may have the advantages of lower reaction temperature (e.g., 95° C.), lower reaction pressure (e.g., atmosphere pressure), simpler solvent system (e.g., the solvent mixture 11 in the aqueous solution 10 including water and carboxylic acid or a variation thereof), shorter reaction time (e.g., 6 hours to 12 hours), and higher purification yield (e.g., 81.2%), and higher scalability (e.g., the reaction apparatus 20 with a 5-L reaction capacity) in comparison to existing methods of synthesizing MOF-based materials.

Still further, referring to FIG. 3, organic ligands with different chemical compositions may endow the MOF-based materials with different properties. For example, with a common metal core 70, altering the chemical compositions of the organic ligands 72A-72E lead to differences in each of surface area (SA), pore volume (i.e., porosity), and small cage size between the corresponding MOF-based material. Methods are provided (e.g., the method 100) for synthesizing a variety of MOF-based materials. For example, the second reactant 18 may include terephthalic acid (or a variation thereof)-based organic ligands functionalized with one or more —NH₂, —OH, —F, and —COOH. Alternatively, the second reactant 18 may include terephthalic acid without additional functional group(s).

### EXAMPLES AND EXPERIMENTAL RESULTS

### Preparation of Example 1-A MOF-Based Material

A MOF-based material (“Example 1”) was prepared according to an embodiment of the method 100 provided herein. 520 mmol of zirconium chloride (i.e., the first reactant 16) and 500 mmol of 2,5-dihydroxy terephthalic acid (e.g., the second reactant 18) were added (e.g., sequentially added; at S1) to a round bottom flask (e.g., the reaction vessel 8) containing a mixture (e.g., the solvent mixture 11) of 2000 mL of acetic acid (e.g., the reaction modulator) and 3000 mL of deionized water (e.g., the aqueous solvent 12) to form a mixture (e.g., the aqueous solution 10). The mixture was then stirred evenly.

The mixture was heated (e.g., at S2) by a hot plate (e.g., the hot plate 24) and stirred (by the hot plate as well) using a magnetic stirrer placed in the round-bottomed flask. The round-bottom flask was then connected to a condensation reflux tube (e.g., the condenser 28) as a part of a reaction apparatus (e.g., the reaction apparatus 20), allowing the reaction between the zirconium chloride and the 2,5-dihydroxy terephthalic acid to proceed under a reflux condensation heating condition. The condensation reflux tube was cooled during the synthesis process by receiving flowing water at an inlet (e.g., the inlet 28A) and expelling the water at an outlet (e.g., the outlet 28B). The mixture was heated to about 95° C. and stirred at a rate of about 600 rpm for a duration of about 6 hours to obtain a crude product (e.g., the crude product 30) that includes a MOF-based material.

The crude product was collected and cooled (e.g., at S3) to room temperature. After performing a centrifugation process (e.g., the initial centrifugation process), about 5000 mL of DI water (e.g., the first diluent) was added to the crude product, mixed well, and let stand for about 12 hours. After performing a centrifugation process (e.g., the second centrifugation process) and washing, more DI water was added, and the supernatant was discarded. This cycle of centrifugation, DI water addition, and supernatant removal was repeated three times, for example, to extract the crude product from the mixture. A cycle of performing centrifugation (e.g., the third centrifugation process; at S4), adding anhydrous ethanol (e.g., the second diluent) to the crude product, and discarding any supernatant was repeated (e.g., at S4) three times to obtain purified crude product.

The purified crude product was placed in a vacuum drying oven and dried (e.g., at S5) at about 120° C. for about 12 hours. After cooling to room temperature and drying, the MOF-based material having a UiO-66-(OH)₂ (Zr) structure was obtained. A schematic structure of such MOF structure is shown in FIG. 3. Thereafter, the MOF-based material was pressed and compacted into blocks of adsorbent samples (e.g., at S6) under a pressure of about 10 MPa. The adsorbent samples (e.g., the adsorbent samples 62) including UiO-66-(OH)₂ (Zr) were then analyzed and tested (e.g., at S7) for adsorption capacities of SO₂ and NO₂ at trace concentrations using a custom-made breakthrough system.

### Preparation of Example 2-MOF-Based Materials

A MOF-based material (“Example 2”) was prepared according to another embodiment of the method 100 provided herein. 520 mmol of zirconium oxychloride (e.g., the first reactant 16) and 500 mmol of 2-amino terephthalic acid (e.g., the second reactant 18) were added (e.g., sequentially added; at S1) to a round bottom flask (e.g., the reaction vessel 8) containing a mixture (e.g., the solvent mixture 11) of 2000 mL of acetic acid (e.g., the reaction modulator) and 3000 mL of deionized water (e.g., the aqueous solvent 12) to form a mixture (e.g., the aqueous solution 10). The mixture was then stirred evenly.

The mixture was heated (e.g., at S2) by a hot plate as described above and stirred (by the hot plate as well) using a magnetic stirrer placed in the round-bottomed flask. The round-bottom flask was then connected to a condensation reflux tube as described above, allowing the reaction between the zirconium chloride and the 2,5-dihydroxy terephthalic acid to proceed under a reflux condensation heating condition. The condensation reflux tube was cooled during the synthesis process by receiving flowing water at the inlet and expelling the water at the outlet of the condensation reflux tube. The mixture was heated to about 95° C. and stirred at a rate of about 600 rpm for a duration of about 6 hours to obtain a crude product (e.g., the crude product 30) that includes a MOF-based material.

The crude product was collected and cooled (e.g., at S3) to room temperature. After performing a centrifugation process (e.g., the initial centrifugation process), about 5000 mL of DI water (e.g., the first diluent) was added to the crude product, mixed well, and let stand for about 12 hours. After performing a centrifugation process (e.g., the second centrifugation process) and washing, DI water was added, and the supernatant was discarded. This cycle of centrifugation, more DI water addition, and supernatant removal was repeated three times, for example, to extract the crude product from the mixture. A cycle of performing centrifugation (e.g., the third centrifugation process), adding anhydrous ethanol (e.g., the second diluent) to the crude product, and discarding any supernatant was repeated (e.g., at $4) three times to obtain purified crude product.

The purified crude product was placed in a vacuum drying oven and dried (e.g., at S5) at about 120° C. for about 12 hours. After cooling to room temperature and drying, the MOF-based material having a UiO-66-NH₂ (Zr) structure was obtained. A schematic structure of such MOF structure is shown in FIG. 3. Thereafter, the MOF-based material was pressed and compacted into blocks of adsorbent samples as described above under a pressure of about 10 MPa. The adsorbent samples (e.g., the adsorbent samples 62) including UiO-66-NH₂ (Zr) were then analyzed and tested (e.g., at S7) for adsorption capacities of SO₂ and NO₂ at trace concentrations using the custom-made breakthrough system.

### Analysis of Physical Properties of MOF-Based Materials

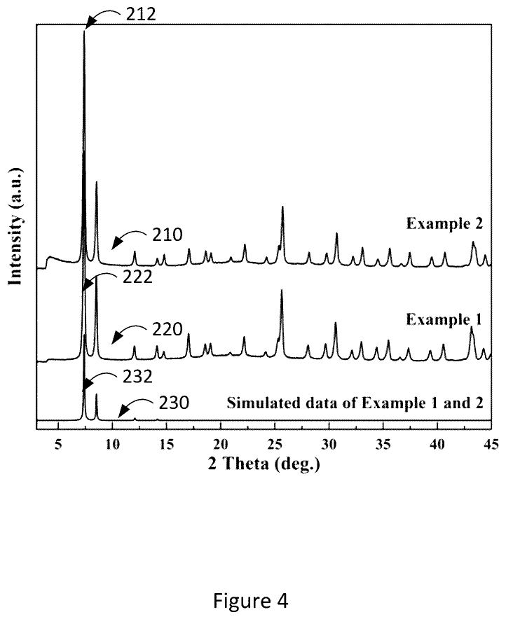

Various physical properties of Example 1 and Example 2 are analyzed (e.g., at S7) as described above and presented below in reference to FIGS. 4-8.

Referring to FIG. 4, a powder X-ray diffraction (p-XRD) spectrum 210 of Example 1, a p-XRD spectrum 220 of Example 2, and a p-XRD spectrum 230 of a simulated example MOF-based material (“Reference”) are shown. As described above, Example 1 includes the synthesized UiO-66-(OH)₂ (Zr) adsorbent samples, Example 2 includes the synthesized UiO-66-NH₂ (Zr) samples, and Reference corresponds to data of a simulated UiO-66(Zr) sample. It can be shown that position of a main peak 212 of the p-XRD spectrum 210 substantially aligns with positions of a main peak 222 of the p-XRD spectrum 220 and a main peak 232 of the p-XRD spectrum 230. Furthermore, a shape of each of the main peaks 212 and 222 is sharp and tall, indicating high peak intensity for each of Example 1 and Example 2. Together, these features confirm the successful synthesis of well crystallized target product, i.e., the MOF-based material including UiO-66-(OH)₂ (Zr) and UiO-66-NH₂ (Zr), respectively.

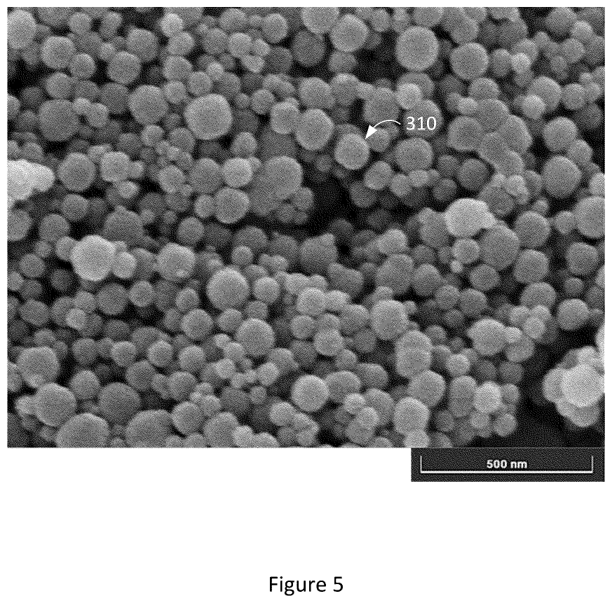

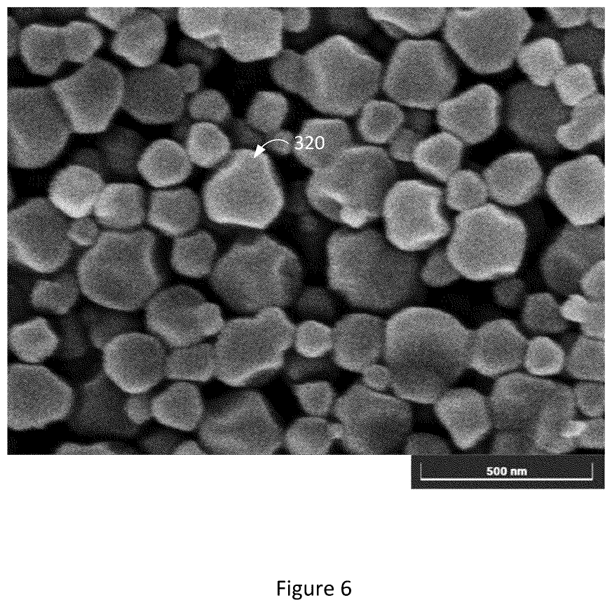

Referring to FIGS. 5 and 6, field emission scanning electron microscope (FE-SEM) images depicting particle morphology of Example 1 and Example 2 are shown, respectively. As shown in FIG. 5, particles 310 of Example 1 generally exhibit substantially uniform spherical shapes with substantially uniform particle sizes (i.e., particle diameter) of about 100 nm. In comparison, referring to FIG. 6, particles 320 of Example 2 generally exhibit substantially polyhedron shapes (e.g., star-shaped with blunt corners) with particle sizes ranging from about 100 nm to about 250 nm.

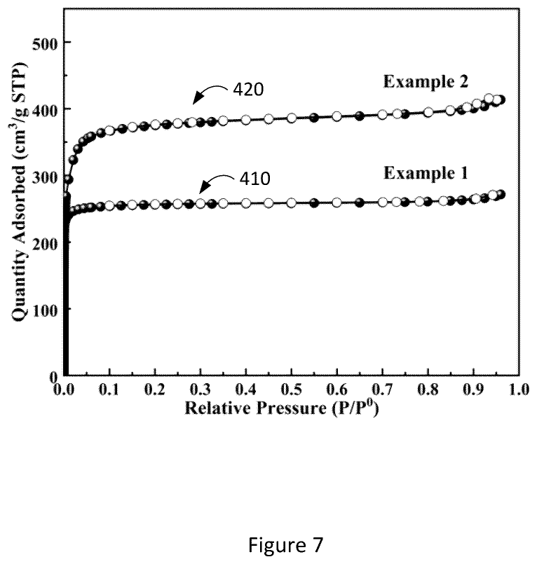

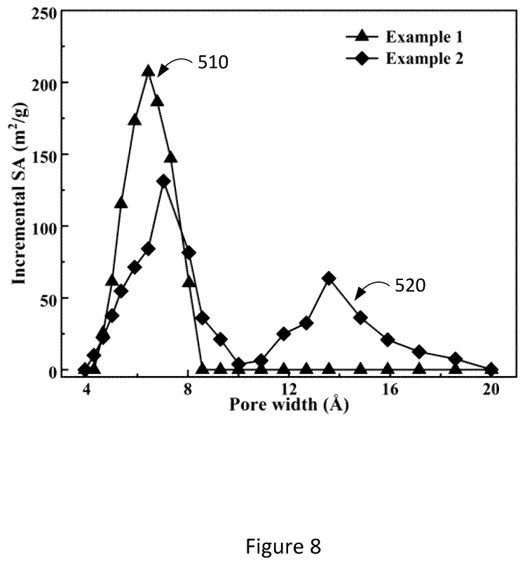

Referring to FIG. 7, an N₂ isotherm curve 410 of Example 1 and an N₂ isotherm curve 420 of Example 2, both measured at 77K, are shown. The N₂ isotherm curves 410 and 420 suggest that the Brunauer-Emmett-Teller (BET) surface areas (SAs) of Example 1 and Example 2, as indicated by quantity of N₂ adsorbed over a range of relative pressures, are 1040 m² g⁻¹ and 1300 m² g⁻¹, respectively. Referring to FIG. 8, comparing Example 1 (dataset 510) with Example 2 (dataset 520) in terms of their incremental SAs over pore widths, pore size distributions of each example can be determined. The results indicate that the pore size distribution for each of Example 1 and Example 2 is concentrated at 7 Å and 14 Å, consistent with the theoretical UiO-66 molecular cage size.

### Analysis of Adsorption Properties of MOF-Based Materials

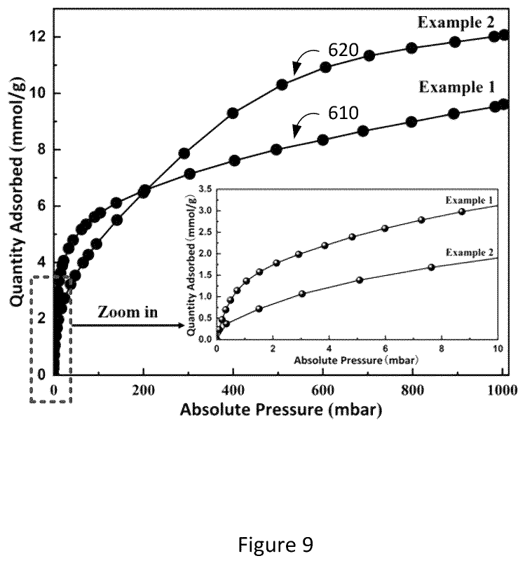

Adsorption properties of Example 1 and Example 2 are analyzed (e.g., at S7) as described above and presented below in reference to FIGS. 9-14.

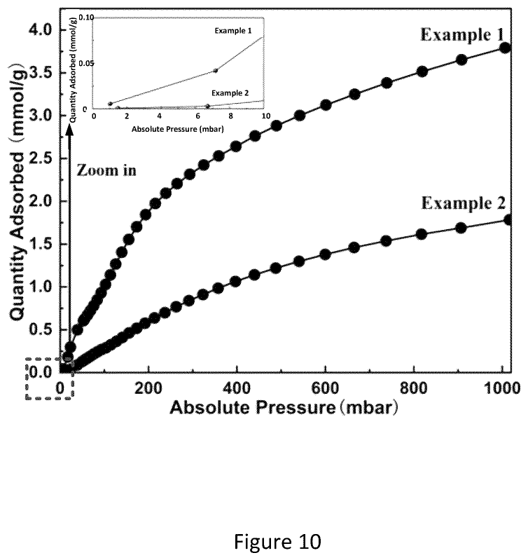

Referring to FIG. 9, a SO₂ isotherm adsorption curve 610 of Example 1 and a SO₂ isotherm adsorption curve 620 of Example 2, both measured at 298 K and over a range of 0 bar to 1.0 bar, are shown. The results indicate that Example 1 exhibits an adsorption capacity of SO₂ of about 0.46 mmol g⁻¹ to about 3.34 mmol g⁻¹ at a pressure ranging from 0.0001 bar to 0.01 bar, and Example 2 exhibits an adsorption capacity of SO₂ of about 0.36 mmol g⁻¹ to about 1.97 mmol g⁻¹ at the same pressure range. These results demonstrate the potential of the MOF-based materials (e.g., Example 1 and the Example 2) produced by the methods provided herein in the field of capturing trace amounts of SO₂. FIG. 10 demonstrates counterpart measurements of adsorption capacities of Example 1 and Example 2 in capturing trace amounts of NO₂.

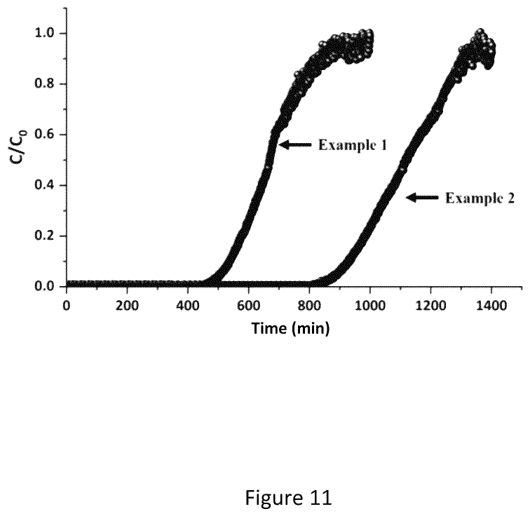

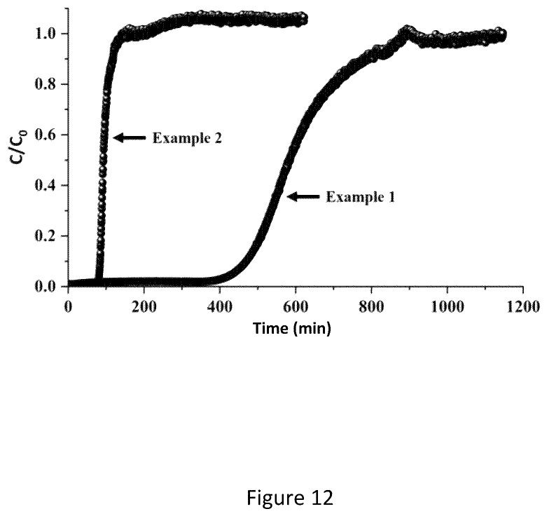

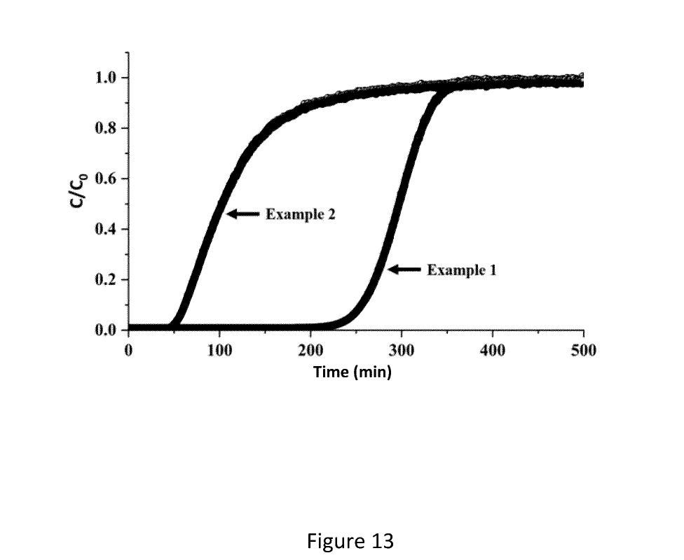

FIGS. 11, 12, and 13 illustrate various breakthrough curves in mixture gases of SO₂ and N₂ for Example 1 and Example 2. Each breakthrough curve reflects a ratio of the real-time concentration (C) of a specific gas (e.g., SO₂ or NO₂) to the initial concentration (Co) thereof measured over time (e.g., in minutes). The results indicate that Example 1 exhibits an SO₂ adsorption capacity of about 0.06 mmol g⁻¹ (FIG. 11), about 0.16 mmol g⁻¹ (FIG. 12), and about 0.90 mmol g⁻¹ (FIG. 13) at concentration levels of 0.003% SO₂/99.997% N₂, 0.01% SO₂/99.99% N₂, and 0.1% SO₂/99.9% N₂, respectively. The results further indicate that Example 2 exhibits an SO₂ adsorption capacity of about 0.10 mmol g⁻¹ (FIG. 11), about 0.12 mmol g⁻¹ (FIG. 12), and about 0.69 mmol g⁻¹ (FIG. 13) at concentration levels of 0.003% SO₂/99.997% N₂, 0.01% SO₂/99.99% N₂, and 0.1% SO₂/99.9% N₂, respectively. These results demonstrate promising SO₂ adsorption performance of Example 1 and Example 2 in the field of capturing trace amounts of SO₂.

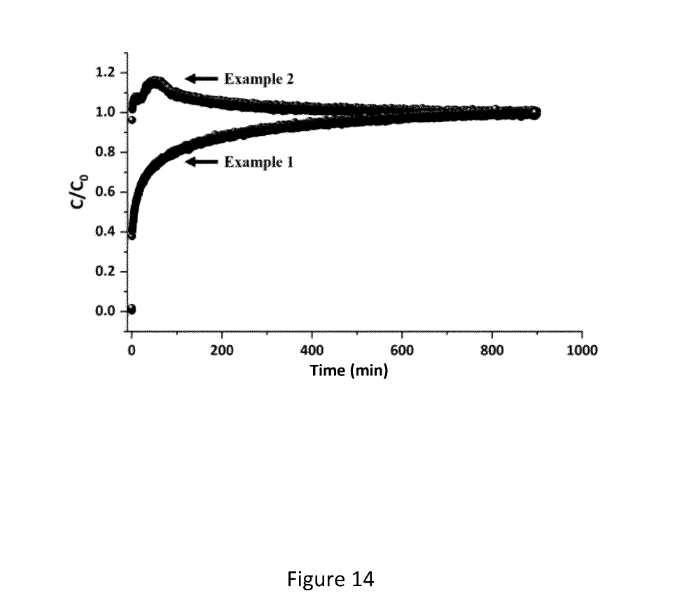

FIG. 14 illustrates the breakthrough curves in mixture gases of NO₂ and N₂ for Example 1 and Example 2, both measured at a NO₂ concentration of 0.003% in mixture gases of NO₂ and N₂ (i.e., a N₂ concentration of 99.997%) under 70% RH. The results indicate that Example 1 exhibits a NO₂ adsorption capacity of about 0.006 mmol g⁻¹ and Example 2 exhibits a NO₂ adsorption capacity of about 0.0003 mmol g⁻¹, demonstrating the potential of these materials in the field of capturing trace amount of NO₂ under humid condition. The results obtained from FIGS. 11-14 are provided in Table 1 below.

TABLE 1
Adsorption capacities of Example 1 and Example
2 for capturing trace amounts of SO₂ and NO₂

| | q_{SO2} mmol g⁻¹ | | | q_{NO2} mmol g⁻¹ |
|---|---|---|---|---|
| MOF- | 0.003%/ | 0.01%/ | 0.1%/ | 0.003%/ |
| Based | 99.997% | 99.99% | 99.9% | 99.997% |
| Material | SO₂/N₂ | SO₂/N₂ | SO₂/N₂ | NO₂/N₂* |
| Example 1 | 0.06 | 0.16 | 0.90 | 0.006 |
| Example 2 | 0.10 | 0.12 | 0.69 | 0.0003 |

*70% RH

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

As used herein, the term “about” generally means plus or minus 5% of the stated value. For example, about 0.5 would include 0.475 and 0.525, about 10 would include 9.5 to 10.5, about 1000 would include 950 to 1050.

The term “coupled,” “linked,” “connected,” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

What is claimed is:

1. A method, comprising:
preparing an aqueous solution that includes a first reactant, a second reactant different from the first reactant, and a reaction modulator, the first reactant including a metal compound and the second reactant including an organic ligand;
synthesizing a crude product that includes a metal-organic framework (MOF)-based material in the aqueous solution, the MOF-based material having a structure that includes a metal core of the first reactant linked by the organic ligand of the second reactant;
extracting the crude product from the aqueous solution;
purifying the extracted crude product; and
drying the purified crude product to obtain the MOF-based material.

2. The method of claim 1, wherein preparing the aqueous solution includes:
mixing the reaction modulator with an aqueous solvent to form a solvent mixture, and
dissolving the first reactant and the second reactant in the solvent mixture to form the aqueous solution.

3. The method of claim 1, wherein synthesizing the crude product includes:
heating the aqueous solution in a thermal bath, and
mechanically stirring the aqueous solution.

4. The method of claim 3, wherein heating the aqueous solution and mechanically stirring the aqueous solution are implemented simultaneously.

5. The method of claim 1, wherein extracting the crude product includes:
performing a first centrifugation process to separate the crude product from the aqueous solution,
adding a first diluent to the separated crude product, the first diluent including water, and
performing a second centrifugation process to extract the crude product from the added first diluent.

6. The method of claim 5, wherein purifying the extracted crude product includes:
adding a second diluent to the extracted crude product, the second diluent including an alcohol, and
performing a third centrifugation process to extract the crude product from the added second diluent.

7. The method of claim 1, wherein drying the purified crude product is implemented using a vacuum drying apparatus.

8. The method of claim 1, wherein:
the dried MOF-based material is in a powdered form, and
the method further comprises compacting the dried MOF-based material into a sample.

9. The method of claim 1, wherein the metal compound is a salt that includes zirconium (Zr) or hafnium (Hf).

10. The method of claim 1, wherein the organic ligand includes one or more of —NH₂, —OH, —F, and —COOH.

11. The method of claim 1, wherein the organic ligand includes one or more of terephthalic acid, trimesic acid, 1,3,5-tris(4-carboxyphenyl)benzene, 2,5-dihydroxy terephthalic acid, and 2-amino terephthalic acid.

12. The method of claim 1, wherein the reaction modulator includes an acid.

13. A method, comprising:
preparing an aqueous solution that includes a first reactant, a second reactant different from the first reactant, and a reaction modulator, the first reactant including a metal compound and the second reactant including an organic ligand;
synthesizing a crude product that includes a metal-organic framework (MOF)-based material in the aqueous solution, wherein the MOF-based material has a structure that includes a metal core of the first reactant linked by the organic ligand of the second reactant, and wherein synthesizing the crude product includes:
heating the aqueous solution in a thermal bath, and
mechanically stirring the aqueous solution;
extracting the crude product from the aqueous solution using a first diluent including water;
purifying the extracted crude product using a second diluent including an alcohol; and
drying the purified crude product to obtain the MOF-based material.

14. The method of claim 13, wherein heating the aqueous solution is implemented at a temperature of about 60° C. to about 150° C.

15. The method of claim 13, wherein mechanically stirring the aqueous solution is implemented at a rate of 100 rpm to 2000 rpm.

16. The method of claim 13, wherein heating the aqueous solution and mechanically stirring the aqueous solution are implemented simultaneously.

17. The method of claim 13, wherein the organic ligand includes one or more of terephthalic acid, trimesic acid, 1,3,5-tris(4-carboxyphenyl)benzene, 2,5-dihydroxy terephthalic acid, and 2-amino terephthalic acid.

18. The MOF-based material produced by the method of claim 13, wherein the MOF-based material has a UiO-66-type structure that includes the metal core of the first reactant linked by a plurality of the organic ligands of the second reactant.

19. The MOF-based material of claim 18, wherein:
the metal core includes Zr or Hf, and
the organic ligand includes one or more of —NH₂, —OH, —F, and —COOH.

20. An adsorbent including the MOF-based material produced by the method of claim 13.
